(19) United States
(12) Patent Application Publication
(10) Pub. No.: US 2026/0223785 A1
(43) Pub. Date: Aug. 6, 2026

(54) LIGHTING SYSTEM AND METHOD FOR PLANT GROWTH

(71) Applicant: SIGNIFY HOLDING B.V., EINDHOVEN (NL)

(72) Inventors: SABRINA ALMEIDA DE CARVALHO, EINDHOVEN (NL); CELINE CATHERINE SARAH NICOLE, EINDHOVEN (NL); MARTIN BOEREMA, ANDOVER (NL); ESTHER DE BEER, WAALRE (NL)

(21) Appl. No.: 19/150,585

(22) PCT Filed: Jan. 23, 2024
(86) PCT No.: PCT/EP2024/051520

§ 371 Date: Jul. 24, 2025

Related U.S. Application Data
(60) Provisional application No. 63/441,474, filed on Jan. 27, 2023.

(51) Int. Cl. A01G 7/04; A01G 22/00; H05B 47/16

(52) U.S. Cl. CPC A01G 7/045; A01G 22/705; H05B 47/16

(57) ABSTRACT

Systems and methods for providing horticulture light to a cannabis plant during a flowering stage of the cannabis plant are disclosed, wherein a spectral power distribution and/or an intensity of the horticulture light is controlled such that an amount of deep red photons in the horticulture light emitted by a horticulture lighting device is at or below a white tip induction threshold during at least a first week of the flowering stage of the cannabis plant.

### FIELD OF THE INVENTION

The invention relates to a method, a controller and a system for controlling illumination in a plant growing environment and further relates to a computer program product enabling a controller to perform such a method.

### BACKGROUND OF THE INVENTION

Plants of the genus Cannabis (“cannabis”) are flowering annual plants, which includes at least the species Cannabis sativa. Cannabis indica and Cannabis ruderalis are either seen as sub-species/varieties of Cannabis sativa, or as separate species (under the genus Cannabis) in their own right.

Cannabis flowers produce valuable phytochemicals as a by-product, such as terpenes and cannabinoids (such as THC and CBD). It is known to use several of these phytochemicals to relieve the symptoms of a number of medical conditions, such as relieving pain and/or preventing nausea. There is a worldwide interest in the medical use of cannabis, and an increasing trend towards legalizing the medical use of cannabis.

It is usually considered necessary to grow cannabis under controlled circumstances to be able to guarantee a sufficient quality of produce for medicinal purposes. For this reason, growth mostly takes place in greenhouses or indoor environments (e.g., without daylight). For improved and repeatable quality, e.g., improved and reproducible phytochemical content, supplemental light (e.g., provided by an LED arrangement) is often used.

A typical growth cycle of a cannabis plant in a commercial greenhouse or indoor setting consists of several distinguishable growth phases. Plants begin in the seedling phase, in which young plants are propagated from seeds or from cuttings taken from a female mother plant. Plants then move to the vegetative phase, in which the female plants are transplanted to a lower plant density and grown to a certain degree of maturity. This is called the vegetative phase. After the vegetative phase, there is a flowering phase that start with a transition to the reproductive phase (i.e., flowering). Cannabis plants are so-called short-day plants. They start flowering when the photoperiod is shortened. To induce flowering, the photoperiod is shortened to typically 12 hours per day. At the end of the flowering phase, the flowers are harvested (a destructive process).

Medical cannabis cultivation is quickly shifting to indoor environments, especially in totally controlled environment under artificial lighting. Light intensities during the flowering phase of cultivation are as high as 1000 μmol/m2/s or even 1500 μmol/m2/s.

The use of horticulture LED lighting with the most efficient spectra for plant growth drives the cannabis plant to stress at its meristem (the tip of the flowering branches) causing the flowers at the top to grow a white top/white tip (FIG. 1) instead of their usual green/purple inflorescence. This white tip syndrome causes flower yield loss and revenue loss, as the flower, which has the largest value in the market, becomes unsalable with a white tip.

Growers identify this white tip effect as photobleaching. However, photobleaching is generally defined as: “Prolonged exposure to excess light that causes photoinhibition, that is decrease in photosynthetic activity, followed by chlorosis—bleaching of chlorophylls (Chl)—and ultimately death.” (Lingvay et al. 2020). White tips do not fit this definition, as plants show a white meristem (no chlorophyll presence from start) that continues to grow white without detriment to plant health or chemistry. The mechanism for this white tip is new and unknown to scientists. In literature some mutant plants have shown that they grow albinic shoots under particular environmental conditions such as high light levels. No studies have been found for an explanation of this specific mechanism. It is unclear as to what this white tip physiological mechanism actually is.

### SUMMARY OF THE INVENTION

The conventional use of LED lighting in horticulture, with the most efficient spectra for growth typically comprised of about 80% red because red LEDs are the most efficient light sources in converting electrical energy into photons, drives the cannabis plant to saturating level of photosynthesis, most probably resulting from Photosystem II (PSII) inhibition. Therefore, high-efficient horticulture light that is rich in red photons (e.g., 660 nm deep red) may be directly contributing to the possible high light induced white tip in cannabis plants. While such light is already efficient enough to achieve acceptable yield and quality at lower intensities, growers still want to apply higher intensities to increase total yield per grow cycle.

The white tip appearance was analyzed by the inventors in various experiments, and it was concluded that white tip appeared above a certain level of deep photons used in the spectrum of the horticulture light. Use of horticulture light comprising more than about 500-600 μmol/m2/s of deep photons and with a photoperiod of 12 hours, generally used in the flowering phase, triggered white tips after a week. Herein, “photoperiod” refers to the period of time in day that an organism is exposed to light.

The inventors found that partially replacing deep red photons by green photons works well, i.e., using a spectral power distribution with reduced content of deep red photons compared to the most efficient spectra for growth which typically comprised about 80% deep red photons. However, for growers using very high photosynthetic photon flux densities (PPFD) such as 1000, 1220 or 1500 μmol/m2/s, even with the partially replaced deep red photon content in the spectrum, the threshold of deep red photon flux is still exceeded. Therefore, white tips will also occur with a spectral power distribution which is low in deep red photon flux percentage but high in intensity.

The inventors also found that by crossing the threshold level of 500-600 μmol/m2/s deep red photons in the horticulture light by week 3 of the flowering stage, i.e., moving from a lower amount of deep red photons before week 3 towards higher amounts of deep red photons in week 3, some level of white tip induction could occur, suggesting that preparation of the plants for high intensity of deep red photon flux is needed.

With full spectrum white (FSW) spectral compositions of horticulture light, such as a spectral power distribution of 40-60% deep red, 15-22 % blue and 20-40% green, white tips appear at only very high intensity (e.g. 1400 μmol/m2/s), while with a more efficient white spectral composition of horticulture light, such as a spectral power distribution of 60-90% deep red, 5-20% blue, and 5-20 % green, white tips are appearing already at relatively lower intensity of 600 to 900 μmol/m2/s.

The invention is defined by the appended claims and relates to a method of providing light to a cannabis plant during a flowering stage of the cannabis plant according to claim 1, a controller for controlling a horticulture lighting device for emitting horticulture light to a cannabis plant during a flowering stage of the cannabis plant according to claim 7, a horticulture lighting device according to claim 12, a horticulture lighting system according to claim 13 and a computer program product according to claim 14. Further advantageous embodiments are claimed in the dependent claims.

The principles underlying the claimed invention will now be discussed in more detail.

### Dynamic Spectral Variation of Horticulture Light for Growing Cannabis by Gradually Increasing the Contribution of Deep Red Photons in the Horticulture Light

In a first aspect, the present disclosure proposes a smart use of deep red photons during the growth cycle, more specifically, during the flowering stage so as to avoid white tip induction or appearance while keeping high quality light for plant growth and high light use efficiency. The proposed solution comprises a dynamic control of the amount of deep red photons in the horticulture light as a function of time during the flowering stage, starting with low amounts of deep red photon in the beginning of the flowering stage and gradual increasing the amount of deep red photons during the flowering stage to avoid triggering white tips towards the end of the flowering stage. The purpose of this dynamic spectral modulation of the horticulture light during the flowering stage is to provide an as energy efficient as possible lighting solution, e.g., in terms of photon effectiveness for plant growth and flowering. Therefore, the low amount of deep red photons in the horticulture light in the beginning of the flowering stage, compared to known high efficient spectra for horticulture growth and flowering, is compensated by green and/or blue photons to maintain an overall light intensity of the horticulture light in terms of μmol/m2/s of photons across the full spectral range of horticulture light suitable for growth and flowering. During progression through the flowering stage, the green and/or blue photons may be gradually replaced by deep red photons.

In the context of this disclosure, the flowering stage may also be referred to as or comprise inflorescence development.

It appears that the amount of deep red photons are the fundamental key to control white tip induction or triggering. The present disclosure therefore provides a controller adapted to control the spectral power distribution of horticulture light generated by a horticulture lighting device adapted to generate blue and deep red light and optionally green light, to implement a light recipe wherein the light recipe starts with a spectral power distribution of the horticulture light having higher levels of green and/or blue and lower levels or deep red, compared to known high efficient horticulture light spectra, and over time gradually changes towards a spectral power distribution of the horticulture light with efficient levels of deep red, green and/or blue as available in known high efficient horticulture light spectra. With such a light recipe the deep red photon flux is kept below the white tip induction threshold during the critical weeks in flower development, guaranteeing low stress in the plant. Herein, the white tip induction threshold is around 500 μmol/m2/s of deep red photons, “high deep red” is regarded as an amount of deep red photons of more than 500 μmol/m2/s, “low deep red” is regarded as lower than 500 μmol/m2/s. In horticulture light spectra “deep red” or “DR” is a particular relevant wavelength or wavelength range in the red wavelength range. “Deep red” or “DR” is regarded as light in the wavelength range of 650 nm to 699 nm, especially light with a spectral peak around 660 nm.

“High efficient horticulture light spectra” are regarded as a spectral power distribution comprising 60-90% deep red photons, 5-20% blue photons, and 5-20% green photons. “Blue” is regarded as light in the wavelength range 420 nm to 490 nm, especially light with a spectral peak at around 440-450 nm, and “green” light in the wavelength range from 500 nm to 570 nm, especially light with a spectral peak around 530 nm. Known horticulture light spectra may also comprise a small amount of far-red, where “far-red” is regarded as light in the wavelength range from 700 to 780 nm, especially light with a spectral peak at around 740 nm. A “light recipe” may be defined as set of specifications that define intensity (e.g., in terms of μmol/m2/s), spectral power distribution (e.g., in terms of μmol/m2/s per wavelength or wavelength range), and timing of applying horticulture light. A light recipe may be embodied as a computer program [product] to be executed on a controller for controlling the intensity, spectral power distribution and timing of the horticulture light emitted by a horticulture lighting device.

Preferably, crossing the white tip induction threshold from low deep red to high deep red happens no earlier than the third week in the flowering phase.

As will be described in more detail in the detailed description, with extra green and blue light as a replacement for deep red, it was shown that white tips were avoidable at very high intensities (e.g., above 1000 μmol/m2/s).

Alternatively or additionally to controlling the spectral power distribution of horticulture light generated by a horticulture lighting device, the controller may also be adapted to control the intensity of the horticulture light, to implement a light recipe wherein the light recipe starts with a low light intensity of the horticulture light, keeping the amount of deep red photons below 500 μmol/m2/s at the start of the flowering phase, and over time gradually increases towards a high intensity of the horticulture light, with amounts of deep red photons above 500 μmol/m2/s.

### Dynamic Spectral Modulation of Horticulture Light for Growing Cannabis Under High Light Levels

In a second aspect, the present disclosure proposes a dynamic control of intensity and spectral power distribution of horticulture light to avoid white tips issues while keeping the yield of production high. The proposed spectral power distribution proportionally reduce the amount of deep red photons to avoid white tip triggering and replacing it with photons of another wavelength or wavelength range without saturating the photosynthesis process in the plant. This other wavelength or wavelength range is a combination of “light blue” light, which is regarded as light of wavelengths in the wavelength range of 460 nm to 490 nm, especially light with spectral peak around 470 nm and/or “light red” light, which is regarded as light of wavelengths in the wavelength range of 600 nm to 644 nm, especially light with a spectral peal around 630 nm.

Chlorophyll a and b are two major types of chlorophyll found in plants and green algae. Both are involved in the process of photosynthesis. The main difference between chlorophyll a and b is their role in photosynthesis; chlorophyll a is the principal pigment involved in the photosynthesis whereas chlorophyll b is the accessory pigment, collecting the energy in order to pass into chlorophyll a. Chlorophyll a is the most abundant type of chlorophyll, which absorbs light of wavelengths around 429-430 nm and around 659-662 nm, i.e., the two main absorption peaks of chlorophyll a. Hence, photons of 675 nm and 436 nm that triggers chlorophyll a might affect photosynthesis saturation and white tips more than photons of 642 nm triggering chlorophyll b. This suggests that a horticulture light spectrum aiming at the region of the chlorophyll b bands might reduce the chances of photobleaching. Using a lighting device capable of delivering photons with a wavelength of around 630 nm (i.e., not triggering chlorophyll a absorption) to replace deep red photons of a wavelength around 660 nm (i.e., within the absorption spectrum of chlorophyll a) should be good enough to reduce white tip initiation/triggering but still provide indirectly photosynthesis using heat generated by heat losses from 630 nm absorption.

For the blue region, using a blue wavelength of around 470 nm (i.e., not triggering chlorophyll a or b absorption) instead of a blue wavelength of around 450 nm would also minimize the direct chlorophyll absorption in a similar way.

Both of those wavelengths (i.e., about 470 nm and about 630 nm) are more efficient, in terms of energy efficiency, than green when produced by LEDs for horticulture lighting devices. Horticulture lighting systems today typically use a broad white spectrum composed of 40-60% deep red, 15-22% blue and 20-40% green, with the majority of these lighting systems maximizing the use of green towards levels of about 40%. These spectra are however less energy efficient than spectra using exclusively deep red and blue wavelengths targeting chlorophyll a absorption. The proposed spectral power distribution, using blue of about 470 nm and light red of about 630 nm as a replacement of the most efficient combination of blue (450 nm) and deep red (660 nm), is still close to the most efficient spectrum for horticulture light and requires less of less efficient green light which according to the MacCree curve is less absorbed by plants compared to light blue light and light red light.

In examples of the above principles, the spectral power distribution of the horticulture light is controlled based on the intensity of the horticulture light such that a contribution of spectral power in the light red wavelength range, also referred to herein as an intensity of light red light, is added to partially replace a contribution of spectral power in the deep red wavelength range, such that the contribution of spectral power in the red wavelength range in the horticulture light is limited to or below the above mentioned white tip induction threshold. The higher the intensity of the horticulture light, the higher the contribution of the light red light to the spectral power distribution of the horticulture light. Intensities of horticulture light used in the flowering stage may be between 800 and 1500 μmol/m2/s and higher. In these examples, the intensity is fixed for the entire flowering stage.

In a further example, the intensity of horticulture light in the flowering stage is gradually increased in the course of the flowering stage or part thereof. In order to keep the contribution of spectral power in the deep red wavelength range of the horticulture light below the white tip induction threshold while gradually increasing the intensity of the horticulture light, the contribution of spectral power in the light red wavelength range in the horticulture light will be increased in dependence on the increase in intensity of the horticulture light. Optionally, the intensity of the horticulture light may be reduced during the last weeks, e.g., the last two weeks of the flowering stage. During this phase of decreasing intensity of the horticulture light, the contribution of spectral power in the light red wavelength range is decreased as well while the contribution of spectral power in the deep red wavelength range is maintained at or below the white tip induction threshold.

In the above two examples, the contributions of spectral power in wavelength ranges of blue and/or green in the horticulture light may be kept constant and only the contributions of spectral power in the wavelength ranges of light red and deep red are controlled based on the intensity of the horticulture light and the white tip induction threshold.

In another example, a contribution of spectral power in the wavelength range of light blue (around 470 nm) may be added to the horticulture light. Light blue light of a wavelength outside the chlorophyll a and b absorption peaks, i.e., outside the wavelength range of about 429 to about 453 nm, does not impair white tip occurrence. Additionally, use of light blue light is more energy efficient than use of green light and hence light blue light may be used to (partially) replace green in the horticulture light.

In still another example, the contribution of spectral power in wavelength ranges of deep red light in the horticulture light may be gradually increased in the course of the flowering stage or part thereof, starting from a contribution well below the white tip induction threshold and gradually increasing towards a contribution well above the white tip induction threshold towards the end of the flowering stage. It was found that, although the contribution of spectral power in the deep red wavelength range crosses the white tip induction threshold at some point, the gradual increase doesn't trigger white tip induction as the plant/flower is accustomed to gradually increasing amounts of deep red light. In these examples, variations in contribution of spectral power in the deep red wavelength range may be compensated by variations in contribution of spectral power in the light red wavelength range to the horticulture light, especially when the intensity of the horticulture light during the flowering stage is intended to be kept constant.

While the above aspects primarily relate to the (dynamically) controlling the spectral composition of spectral power distribution of the horticulture light used during the flowering stage of cannabis plants, the present disclosure also relates to a horticulture lighting device comprising LEDs, each for emitting light in a wavelength range selected from a wavelength range of blue, light blue, light red, deep red and green light as defined above, and wherein the LEDs are individually controllable in terms of intensity (or luminous flux or illuminance) to create the herein disclosed spectral power distributions of horticulture light. LEDs of a particular wavelength or wavelength range, e.g., blue, light blue, green, light red, or deep red may be controlled as a group, often referred to as a (color) channel of the horticulture lighting device. Lighting devices comprising a plurality of LEDs of the same or different color or wavelength, wherein the LEDs or groups of LEDs are individually controllable are well known in the art and will not be described in detail in this disclosure.

The horticulture lighting device may be controlled by a controller adapted to individually control the intensity (or luminous flux or illuminance) of each LED or (color) channel within the horticulture lighting device. Controllers for controlling a lighting device comprising a plurality of LEDs of the same or different color or wavelength, e.g., different (color) channels, wherein the controllers are adapted to individually control (an intensity of) the LEDs or groups of LEDs of the lighting device, e.g., individually control each (color) channel, are well known in the art and will not be described in detail in this disclosure.

The present disclosure also relates to a horticulture lighting system comprising a horticulture lighting device and a controller as described herein.

Also disclosed herein is a computer program [product] comprising instructions which, when the program is executed by a controller as described herein, cause the controller to implement the (dynamic) light recipes and/or light spectral power distributions disclosed herein on a horticulture lighting device as disclosed herein.

Further, also disclosed herein is a computer-readable [storage] medium comprising a computer program or a data carrier signal carrying a computer program comprising instructions which, when the computer program is executed by a controller as described herein, cause the controller to implement the (dynamic) light recipes and/or light spectral power distributions disclosed herein on a horticulture lighting device as disclosed herein. Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments as claimed in the invention. It will be understood that the present invention is not in any way restricted to these specific embodiments.

### BRIEF DESCRIPTION OF THE DRAWINGS

These and other aspects will be apparent from and further elucidated, by way of example, with reference to the drawings, in which:

FIG. 1 shows some pictures of the white tip stress in a cannabis plant;

FIG. 2 shows a trial setup with different full spectrum white light intensities;

FIGS. 3 to 5 show various embodiments of a first aspect disclosed herein wherein an amount of deep red photons in the horticulture light is replaced with green, and optionally blue, photons;

FIG. 6 shows the spectral absorption of chlorophyll a (solid line) and chlorophyll b (dashed line);

FIGS. 7 to 12 shows various embodiments of a second aspect disclosed herein wherein an amount of deep red photons in the horticulture light is replaced with light red and optionally blue with light blue.

Corresponding elements in the drawings are denoted by the same reference numeral.

### DETAILED DESCRIPTION OF THE EMBODIMENTS

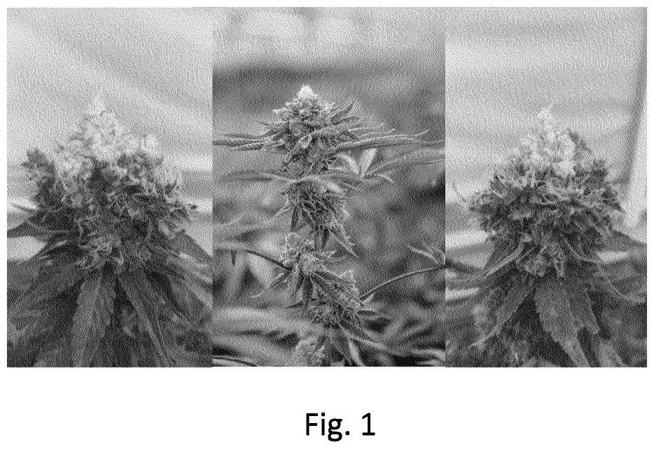

FIG. 1 shows some pictures of the white tip stress in a cannabis plant. The use of horticulture light with high spectral power contributions in deep red light drives the cannabis plant to stress at its meristem (the tip of the flowering branches) causing the flowers at the top to grow a white tip instead of their usual green/purple inflorescence. This white tip syndrome causes flower yield loss and revenue loss, as the flower that has the stress is also the most valuable in the market but with the white tip it becomes unsalable.

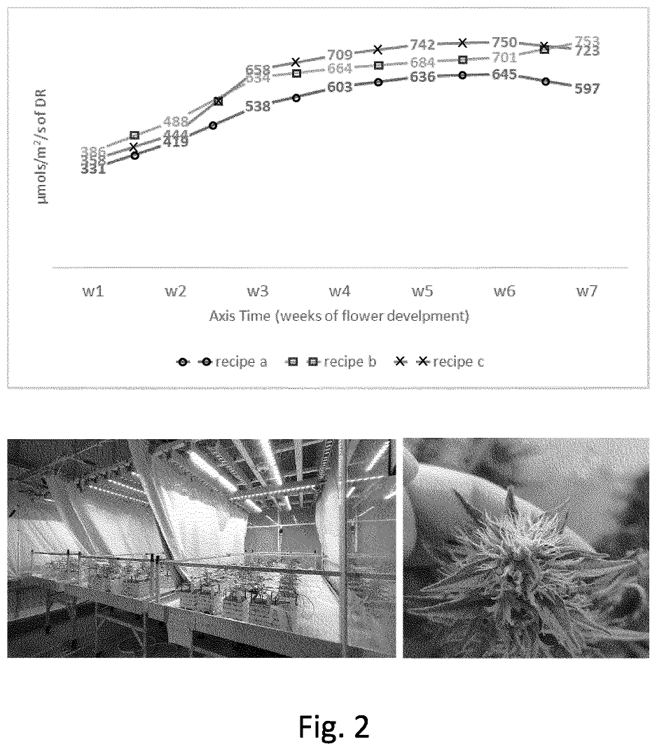

FIG. 2 shows a trial setup with three different ‘full spectrum white light’ light recipes (recipe a-c) where the intensity of the horticulture light is gradually increase during the flowering phase, especially in the first three weeks (w1-w3) of the flowering stage, where the flowering stage takes about seven weeks (w1-w7). The graph in FIG. 2 shows amounts of measured deep red (DR) at top of plant. The trial showed that recipe a was the one that did not generate white tips, as the amount of deep red (DR) in the first 3 weeks was kept under the 500 to 600 μmols/m2/s induction threshold.

### Dynamic Spectral Variation of Horticulture Light for Growing Cannabis by Gradually Increasing the Contribution of Deep Red Photons in the Horticulture Light

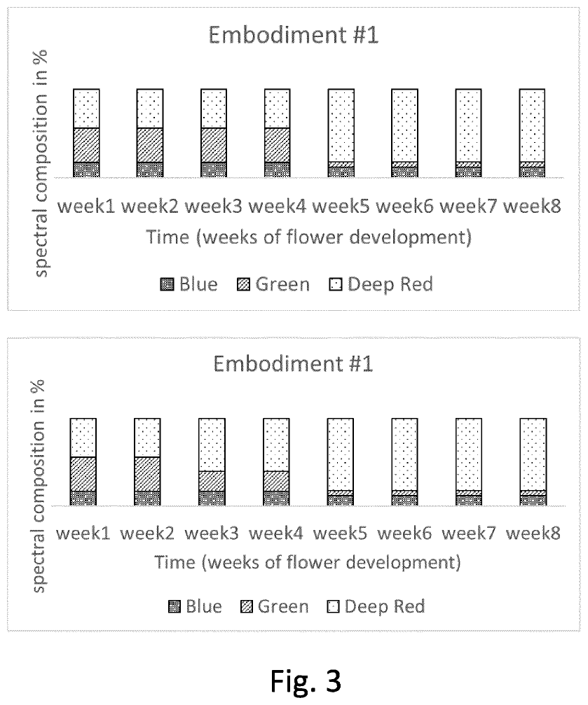

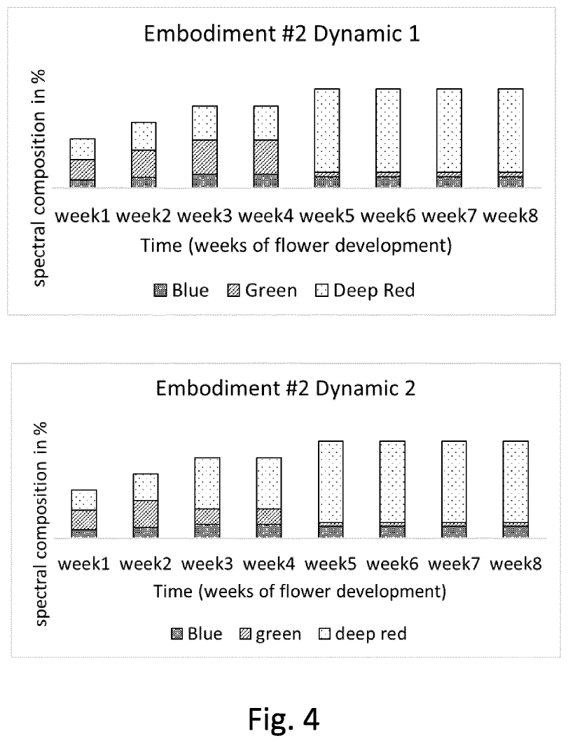

Compared to prior art high-efficient horticulture light spectra that are rich in deep red photons, e.g., spectra having about 80% of the photons in the deep red wavelength of 660 nm, the disclosed dynamic light recipes with dynamic intensity and/or spectral power distribution control according to the first aspect can be implemented in various different ways. FIGS. 3 to 5 shows different embodiments. In all these embodiments, the flowering stage spans eight weeks and the spectral power distribution of the horticulture light comprising blue (450 nm), green (530 nm) and deep red (660 nm) light in various intensity combinations. The intensity of the horticulture light is either kept fixed during the flowering stage or is dynamically controlled to vary during the flowering stage.
FIG. 3 shows an embodiment #1 having a fixed light intensity of the horticulture light from week 1 to week 8 of the flowering stage and only applies a varying spectral power distribution of the horticulture light during the flowering stage. In the upper example of embodiment #1, the contribution of deep red photons in the horticulture light is kept below the white tip induction threshold for the first four weeks of the flowering stage and is then changed to a known efficient contribution of about 80% of deep red photons in the horticulture light for the remaining weeks of the flowering stage. In the lower example of embodiment #1, the contribution of deep red photons in the horticulture light is kept below the white tip induction threshold for the first two weeks of the flowering stage, is then increased to a transitional contribution such as contribution of around 500-600 μmol/m2/s for the next two weeks before further increasing it to the known efficient contribution of about 80% of deep red photons in the horticulture light for the remaining weeks of the flowering stage. In these embodiments, a reduction in the amount of deep red photons in the horticulture light is compensated by an increase in the amount of green photons to keep the overall intensity of the horticulture light in terms of μmol/m2/s constant throughout the flowering stage.
FIG. 4 shows an embodiment #2 having a varying intensity of the horticulture light during the flowering stage in combination with a varying spectral power distribution of the horticulture light during the flowering stage. In the upper example of embodiment #2, the contribution of deep red photons in the horticulture light is kept below the white tip induction threshold for the first four weeks of the flowering stage and is then changed to a known efficient contribution of about 80% of deep red photons in the horticulture light for the remaining weeks of the flowering stage.

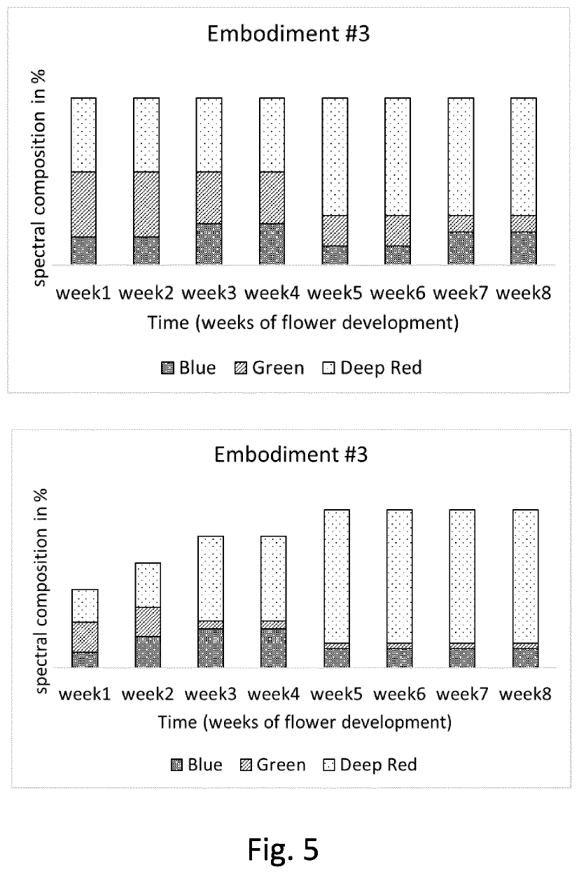

Because the intensity of the horticulture light in this embodiment is also reduced in the these first four weeks of the flowering stage, the contributions of deep red photons in the horticulture light may be selected to be somewhat higher than in the upper example of embodiment #1 without crossing the white tip induction threshold. In the lower example of embodiment #2, the contribution of deep red photons in the horticulture light is kept below the white tip induction threshold for the first two weeks of the flowering stage, is then increased to a transitional contribution such as contribution of around 500-600 μmol/m2/s for the next two weeks before further increasing it to the known efficient contribution of about 80% of deep red photons in the horticulture light for the remaining weeks of the flowering stage. Because the intensity of the horticulture light in this embodiment is also reduced in the these first four weeks of the flowering stage, the contributions of deep red photons in the horticulture light may be selected to be somewhat higher than in the lower example of embodiment #1. In these embodiments, a reduction in the amount of deep red photons in the horticulture light is compensated by an increase in the amount of green photons to keep the overall intensity of the horticulture light in terms of μmol/m2/s constant throughout the flowering stage.
FIG. 5 shows an embodiment #3 having varying ratios of contributions of blue and green, which may be applied to any of the embodiments described above. Whereas in the above embodiments a reduction in the amount of deep red photon was compensated by an increase in the amount of the green photons to maintain the same amount of photons in the horticulture light in terms of μmol/m2/s or intensity of the horticulture light, in embodiment #3, the reduction in the amount of deep red photon is compensated by an increase in the amount of green and/or blue photons to maintain the same amount of photons in the horticulture light in terms of μmol/m2/s or intensity of the horticulture light. In the upper example of embodiment #3, the intensity of the horticulture light is kept constant during the flowering stage and the contribution of deep red photons is kept below the white tip induction threshold during the first four weeks of the flowering stage. In the lower example of embodiment #3, the intensity of the horticulture light is gradually increased during first four weeks of the flowering stage while also the contribution of deep red photons in the horticulture light is gradually increase during the first four weeks of the flowering stage.

In further embodiments, the reduction the contribution of deep red photons in the horticulture light may alternatively or additionally be (partially) compensated by the introductions of far-red photons of a wavelength around 730 nm.

Whereas in the previous embodiments, the contribution of deep red light in the horticulture light in the flowering stage was controlled on a weekly basis to be below the white tip induction threshold in the first weeks of the flowering stage, in an alternative embodiment, the contribution may be controlled on a daily basis, allowing the contribution of deep red light in the first weeks of the flowering stage to exceed the white tip induction threshold only for one or two consecutive days and then reducing it again to be below the white tip induction threshold. The advantage thereof is that horticulture light during these one two consecutive days is more efficient in terms of growth and photosynthesis while still keeping the risk for white tip induction limited. In a further alternative embodiment, the spectral power contribution of the horticulture light may be controlled on an hourly basis, allowing the spectral power distribution of the horticulture light in the first weeks of the flowering stage to approach higher levels of deep red during peak hours of electricity usage (more efficient) and use higher levels of green/blue during low hours of electricity usage (less efficient), wherein the spectral power distributions are controlled between no white tip risk spectra and potentially white tip risk spectra. In general, whether contributions of deep red light in the horticulture light are varied on an hourly, daily or weekly basis, the contribution of deep red light in the horticulture light is preferably controlled with respect to a real-time limit of 500 μmol/m2/s, a daily limit of 21.6 mol/m2/day, or a weekly limit of 151 mol/m2/week in the first weeks of the flowering stage to avoid white tip induction.

Experiments have shown that dynamic light recipes as disclosed above substantially reduce the risk of generating white tips in Cannabis flowers or even eliminate white tips from Cannabis flowering.

### Dynamic Spectral Modulation of Horticulture Light for Growing Cannabis Under High Light Levels

With extra green and blue light as a replacement for deep red, it was shown above that white tips were avoidable even at very high intensities above 1000 μmol/m2/s.

In the second aspect disclosed herein, the inventors propose to, additionally or alternatively, replace an amount of the deep red light in the horticulture light with light red light and/or replace an amount of the blue light in the horticulture light with light(er) blue light. The (gradual) replacement of some of the deep red light and/or some of the blue light during the flowering phase, may be implemented in a dynamic way by controlling the spectral power distribution of the horticulture light as a function of the inflorescence development in the flowering phase of the cannabis plant in order to maximize the energy use for growth and minimize the risk of white tip induction. The maximum amount of deep red photons allowed for growth of cannabis during the flowering cycle without white tip induction, i.e., the white tip induction threshold is an intensity or deep red light of about 500 μmol/m2/s, or 21.6 mol/m2/day, or 151 mol/m2/week. The various combinations as a function of time are shown in the following embodiments.

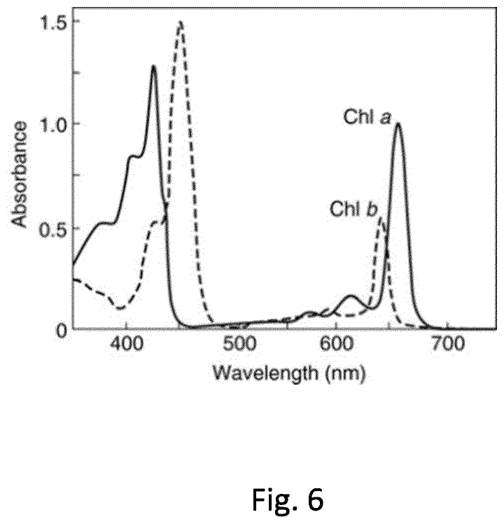

FIG. 6 shows the spectral absorption of chlorophyll a (solid line) and chlorophyll b (dashed line). The chlorophyll a absorption curve shows maximum absorption at blue wavelengths of 436-439 nm and red wavelengths of 667-675 nm. The chlorophyll b absorption curve shows maximum absorption at blue wavelengths of 485-469 nm and red wavelengths of 642-652 nm. Prior art literature suggests that upon light illumination, chlorophyll a is most affected by saturation and photobleaching rather than the chlorophyll b. Moreover, chlorophyll a is more abundant in plants than chlorophyll b. Hence, a horticulture light spectral power distribution composed of red and blue light aiming at chlorophyll b instead of chlorophyll a might reduce the chances of photobleaching and white tip development. In the second aspect disclosed herein, contributions of deep red photons (e.g., nm) in the horticulture light are therefore replaced (at least partially) by contributions of light red photons (e.g., 630 nm) and contributions of blue photon (e.g., 450 nm) in the horticulture light are replaced (at least partially) by light blue photons (e.g., 470 nm).

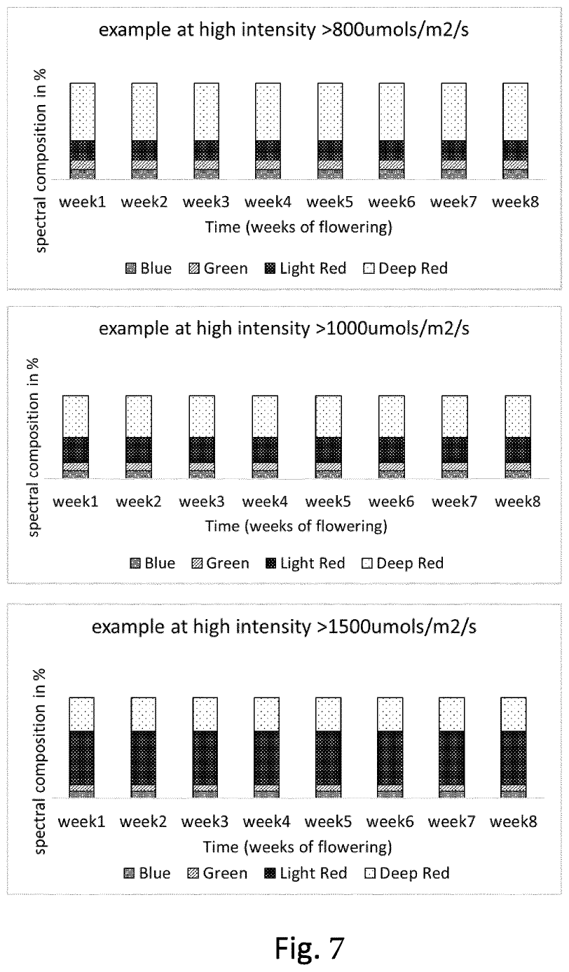

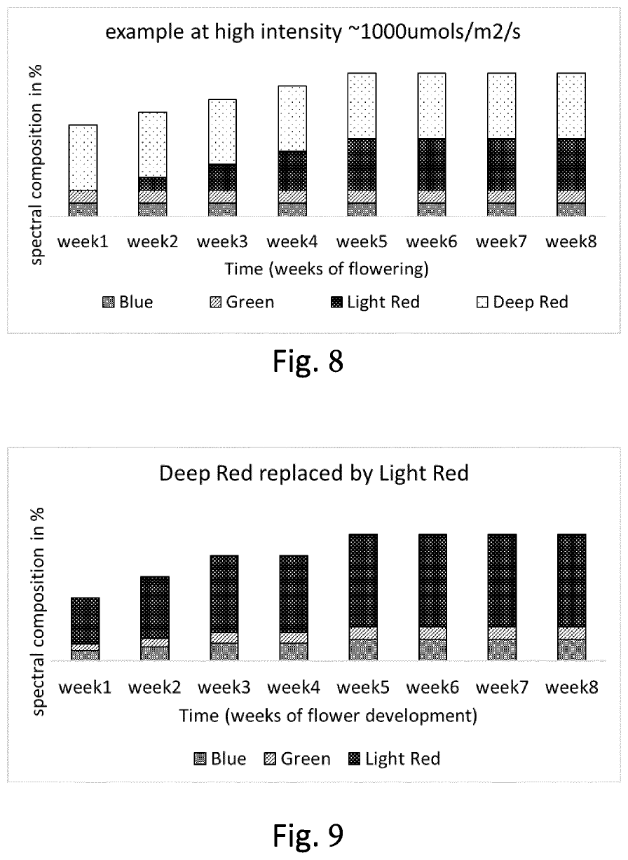

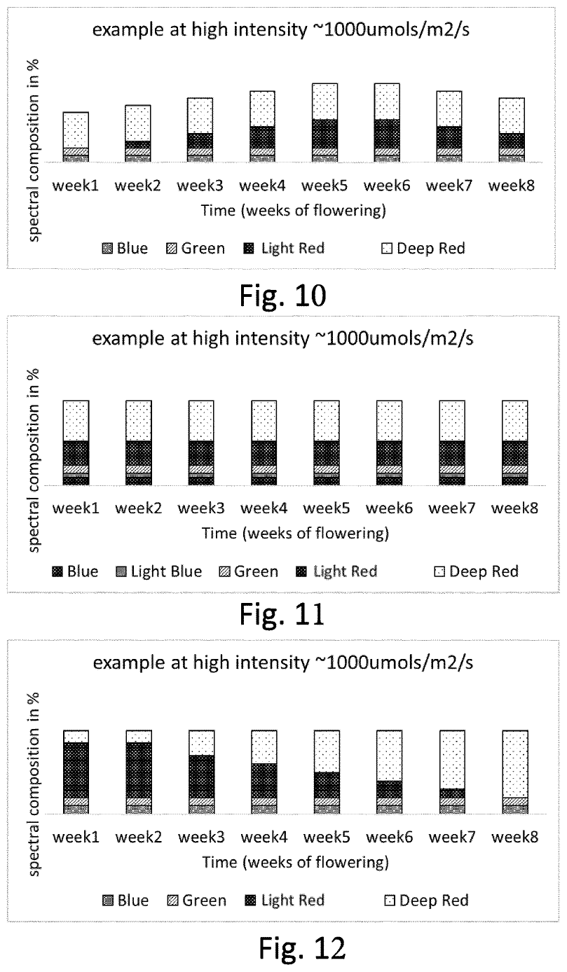

FIGS. 7 to 12 shows different embodiments of the second aspect disclosed herein. In all these embodiments, the flowering stage spans eight weeks and the spectral power distribution of the horticulture light may comprise blue (450 nm), light blue (470 nm), green (530 nm), light red (630 nm) and deep red (660 nm) light in various intensity combinations. The intensity of the horticulture light is either kept fixed during the flowering stage or is dynamically controlled to vary during the flowering stage.
In embodiments shown in FIG. 7, depending on the intensity of the horticulture light applied in a fixed-intensity light recipe for flowering, e.g., 800 μmol/m2/s, 1000 μmol/m2/s and 1500 μmol/m2/s, the amount of light red photons replacing deep red photons is determined in order to keep the total amount deep red photon below the white tip induction threshold.
In another embodiment shown in FIG. 8 a gradual increase of the intensity of the horticulture light during the flowering cycle is applied. Depending on the intensity of the horticulture light at the start of the flowering cycle, the amount of deep red photon in a known high-efficient horticulture light spectrum may already be lower or equal to the white tip induction threshold, not requiring replacement of the high-efficient deep red light by light red light. The amount of light red light may be gradually increased as the intensity of the applied horticulture light is increase during the flowering cycle, keeping the amount of deep red photon at the white tip induction threshold. The embodiment shown in FIG. 8 has been experimentally validated and cannabis flowers have been able to be grown without white tip.
In the embodiment show in FIG. 9, all the deep red light (DR) in horticulture light is replaced by light red. The embodiment shown in FIG. 9 has been experimentally validated and cannabis flowers have been able to be grown without white tip.
In an embodiment shown in FIG. 10, a dynamic light recipe comprises a ramp up of the intensity of the horticulture light towards a maximum intensity over a period of the first weeks of the flowering cycle, followed by a ramp down of the intensity of the horticulture light over a period of the last weeks of the flowering cycle. The contribution of light red photons in the spectral power distribution of the horticulture light varies with the intensity variation of the horticulture light to keep the absolute amount of deep red photons in the horticulture light at or below the white tip induction threshold.
In an embodiment shown in FIG. 11 light blue light (470 nm) is added next to light red light to replace the amount of deep red photons above the white tip induction threshold.
The embodiment shown in FIG. 12 comprises a (linear) ramp up of the amount of deep red photons in the horticulture light over the course of the flowering stage, as it was established that a later phases in the flowering stage high doses of deep red photons would not trigger white tips. The embodiment shows a fixed total intensity of the horticulture light for all weeks of the flowering stage with gradual increase of deep red light intensity.

Whereas in the previous embodiments of the second aspect disclosed herein, the contributions of deep red light versus light red light (and optionally light blue light) in the horticulture light in the flowering stage were controlled on a weekly basis to be below the white tip induction threshold in the first weeks of the flowering stage, in an alternative embodiment, the contributions may be controlled on a daily basis, allowing the contribution of deep red light in the first weeks of the flowering stage to exceed the white tip induction threshold only for one or two consecutive days and then reducing it again to be below the white tip induction threshold. The advantage thereof is that horticulture light during these one or two consecutive days is more efficient in terms of growth and photosynthesis while still keeping the risk for white tip induction limited. In a further alternative embodiment, the spectral power contribution of the horticulture light may be controlled on an hourly basis, allowing the spectral power distribution of the horticulture light in the first weeks of the flowering stage to approach higher levels of deep red during peak hours of electricity usage (more efficient) and use higher levels of light red (and optionally light blue) during low hours of electricity usage (less efficient), wherein the spectral power distributions are controlled between no white tip risk spectra and potentially white tip risk spectra. In general, whether contributions of deep red light in the horticulture light are varied on an hourly, daily or weekly basis, the contribution of deep red light in the horticulture light is preferably controlled with respect to a real-time limit of 500 μmol/m2/s, a daily limit of 21.6 mol/m2/day, or a weekly limit of 151 mol/m2/week in the first weeks of the flowering stage to avoid white tip induction.

It is to be noted that the above described horticulture light spectra comprise an amount of green light. However, the spectra according to the second aspect described herein could also be realized without any green component in the horticulture light or with an amount of far red light.

The description of embodiments of the present invention have been presented for purposes of illustration but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of providing light to a cannabis plant during a flowering stage of the cannabis plant, said method comprising;
providing a horticulture lighting device for illuminating the cannabis plant with horticulture light, the horticulture lighting device comprising at least one deep red light source configured to emit deep red photons in a wavelength range from 650 nm to 699 nm;
controlling a spectral power distribution and/or an intensity of the horticulture light such that an amount of deep red photons in the horticulture light emitted by the horticulture lighting device is at or below a white tip induction threshold during at least a first couple of weeks of the flowering stage of the cannabis plant and thereafter controlling the spectral power distribution and/or intensity of the horticulture light such that the amount of deep red photons in the horticulture light emitted by the horticulture lighting device changes towards levels of deep red above the white tip induction threshold; and
illuminating the cannabis plant with said horticulture light.

2. The method of claim 1, wherein the white tip induction threshold is about 500 mmol/m2/s.

3. The method of claim 1, wherein the amount of deep red photons in the horticulture light is at or below a white tip induction threshold during at least the first three weeks of the flowering stage.

4. The method of claim 1,
wherein the horticulture lighting device comprising at least one green light source configured to emit green photons in a wavelength range of 500 nm to 570 nm, and wherein the method comprises controlling the spectral power distribution and/or the intensity of the horticulture light such that an excess of deep red photons above the white tip induction threshold is replaced by green photons in the horticulture light emitted by the horticulture lighting device; and/or
wherein the horticulture lighting device comprising at least one blue light source configured to emit blue photons in a wavelength range of 420 nm to 490 nm, and wherein the method comprises controlling the spectral power distribution and/or the intensity of the horticulture light such that an excess of deep red photons above the white tip induction threshold is replaced by blue photons in the horticulture light emitted by the horticulture lighting device.

5. The method of claim 1,
wherein the horticulture lighting device comprising at least one light red light source configured to emit light red photons in a wavelength range of 600 nm to 649 nm, and wherein the method comprises controlling the spectral power distribution and/or the intensity of the horticulture light such that an excess of deep red photons above the white tip induction threshold is replaced by light red photons in the horticulture light emitted by the horticulture lighting device; and/or
wherein the horticulture lighting device comprising at least one light blue light source configured to emit blue photons in a wavelength range of 460 nm to 490 nm, and wherein the method comprises controlling the spectral power distribution and/or the intensity of the horticulture light such that an excess of deep red photons above the white tip induction threshold is replaced by light blue photons in the horticulture light emitted by the horticulture lighting device.

6. The method of claim 1, further comprising the step of controlling the spectral power distribution and/or the intensity of the horticulture light such that the light intensity of the horticulture light is gradually increased during at least the first couple of weeks of the flowering stage.

7. A controller for controlling a horticulture lighting device for emitting horticulture light to a cannabis plant during a flowering stage of the cannabis plant, the horticulture lighting device comprising at least one deep red light source configured to emit deep red photons in a wavelength range from 650 nm to 699 nm,
wherein the controller as adapted to control the at least one deep red light source of the horticulture lighting device such that an amount of deep red photons in the horticulture light emitted by the horticulture lighting device is at or below a white tip induction threshold during at least a first week of the flowering stage of the cannabis plant and thereafter control the at least one deep red light source of the horticulture lighting device such that the amount of deep red photons in the horticulture light emitted by the horticulture lighting device changes towards levels of deep red above the white tip induction threshold.

8. The controller of claim 7, wherein the horticulture lighting device further comprises at least one green light source configured to emit green photons in a wavelength range of 500 nm to 570 nm, and/or at least one blue light source configured to emit blue photons in a wavelength range of 420 nm to 490 nm, and
wherein the controller is further adapted to control the at least one green light source and/or the least one blue light source of the horticulture lighting device to thereby control the spectral power distribution and/or the intensity of the horticulture light such that an excess of deep red photons above the white tip induction threshold is replaced by green photons and/or blue photons in the horticulture light emitted by the horticulture lighting device.

9. The controller of claim 7, wherein the horticulture lighting device further comprises at least one light red light source configured to emit light red photons in a wavelength range of 600 nm to 649 nm, and/or at least one light blue light source configured to emit blue photons in a wavelength range of 460 nm to 490 nm, and
wherein the controller is further adapted to control the at least one light red light source and/or the at least one light blue light source of the horticulture lighting device to thereby control the spectral power distribution and/or the intensity of the horticulture light such that an excess of deep red photons above the white tip induction threshold is replaced by light red photons and/or light blue photons in the horticulture light emitted by the horticulture lighting device.

10. The controller of claim 7, adapted to control the light sources of the horticulture lighting device the thereby control the spectral power distribution and/or the intensity of the horticulture light such that the light intensity of the horticulture light is gradually increased during at least the first three weeks of the flowering stage.

11. The controller of claim 7, wherein the white tip induction threshold is about 500 mmol/m2/s.

12. (canceled)

13. A horticulture lighting system comprising
the controller of claim 7, and
a horticulture lighting device comprising at least one deep red light source configured to emit deep red photons in a wavelength range from 650 nm to 699 nm.

14. A computer readable medium comprising instructions which, when the instructions are executed by a controller, causes the controller to perform the method of claim 1.

15. The horticulture lighting system, comprising:
the controller of claim 7, and
wherein the horticulture lighting device further comprises:
at least one green light source configured to emit green photons in a wavelength range of 500 nm to 570 nm;
at least one blue light source configured to emit blue photons in a wavelength range of 420 nm to 490 nm;
at least one light red light source configured to emit light red photons in a wavelength range of 600 nm to 649 nm; and
at least one light blue light source configured to emit blue photons in a wavelength range of 460 nm to 490 nm.
